(19) United States
(12) Patent Application Publication
(10) Pub. No.: US 2023/0321677 A1
(43) Pub. Date: Oct. 12, 2023

(54) Gravity Fed Spray Head

(71) Applicant: Joseph Syryla, Danbury, CT (US)

(72) Inventor: Joseph Syryla, Danbury, CT (US)

(21) Appl. No.: 18/128,139

(22) Filed: Mar. 29, 2023

Related U.S. Application Data
(60) Provisional application No. 63/329,215, filed on Apr. 8, 2022.

(51) Int. Cl. B05B 11/10

(52) U.S. Cl. CPC B05B 11/1047; B05B 11/1011; B05B 11/1057

(57) ABSTRACT

A gravity fed spray head includes a housing, a coupling mounted atop the housing for fastening a container above the housing, a sprayer mounted to a horizontal extension of the housing, a pump mounted inside the housing below the coupling, the pump having an inlet and an outlet facing the coupling, and a trigger having a first end rotatably mounted to the housing below the coupling, and a second end extending below the pump, the trigger coupled to a trigger lever for actuating the pump.

This application claims the benefit of U.S. Provisional Application No. 63/329,215, filed on 8 Apr. 2022, incorporated by reference in its entirety.

### FIELD

The disclosed embodiments are directed to a spray head, in particular to a spray head gravity fed from a container attached overhead.

### BACKGROUND

Most spray bottle assemblies include a container, onto which a spray nozzle is attached. The spray bottle assembly is generally designed to be used upright, with the spray nozzle attached on top of the container with a dip tube that extends from the spray nozzle to the bottom of the interior of the container. The spray nozzle may have a threaded coupling that corresponds to threaded opening at the top of the container, and a trigger operated pump connected to the dip tube that operates to draw liquid contents of the container vertically up the dip tube, through the pump, and out through a nozzle.

When the spray bottle assembly is tilted, the end of the dip tube may no longer extend into the liquid which may require using the spray bottle assembly in a less than optimal more upright position, or when the liquid level is low, the end of the dip tube may no longer extend into the liquid which may require tilting the container to a less than optimal more horizontal position to reach the liquid. In addition, certain spray bottle assemblies may not be capable of ever reaching all the liquid, resulting in waste. Furthermore, a user may have a limited range of motion when the spray nozzle is attached to the top of the container as the container located below the spray nozzle may be too bulky for working in a confined area.

Joe, are there any other drawbacks or problems that the invention solves?

Therefore, there exists a need to overcome the aforementioned drawbacks associated with existing spray bottle assemblies.

### SUMMARY

The aspects of the disclosed embodiments are directed to a spray head for dispensing liquids. The aspects of the disclosed embodiments seek to provide a solution to the existing problems of waste and limited range of motion that are associated with existing spray bottle assemblies.

The disclosed embodiments are directed to a gravity fed spray head including a housing, a coupling mounted atop the housing for fastening a container above the housing, a sprayer mounted to a horizontal extension of the housing, a pump mounted inside the housing below the coupling, the pump having an inlet and an outlet facing the coupling, and a trigger having a first end rotatably mounted to the housing below the coupling, and a second end extending below the pump, the trigger coupled to a trigger lever for actuating the pump.

The housing may have at least three finger grips.

The housing may enclose the pump and the sprayer and trigger may be attached to the housing.

The coupling may be rigidly fixed atop the housing.

The coupling may include internal threads for engaging threads of the container.

The sprayer may include a nozzle configured to spray liquid in an adjustable or fixed pattern.

The gravity spray head may include a feed tube connecting the coupling and the inlet.

The feed tube may include an upper portion with a width corresponding to an inner diameter of the coupling and a lower portion extending from the upper portion to the inlet.

The gravity spray head may include an outlet tube connecting the outlet and the sprayer.

The pump may include a piston biased by a spring and coupled to the trigger by the trigger lever.

The pump may be an electrical pump, and the gravity spray head may also include a power source, and a switch coupled to the trigger lever for actuating the pump, such that when the trigger lever is actuated, the trigger activates the switch to connect the power source to the pump.

Joe, are there any other features of the invention that are missing?

The aspects of the disclosed embodiments substantially eliminate or at least partially address the aforementioned problems of tilting the container to a less than optimal positions to use most of the contents of the container and reduce waste, and providing wider range of motion in spaces below the container.

Additional aspects, advantages, features and objects of the aspects of the disclosed embodiments would be made apparent from the drawings and the detailed description of the illustrative embodiments construed in conjunction with the appended claims that follow.

It will be appreciated that features of the aspects of the disclosed embodiments are susceptible to being combined in various combinations without departing from the scope of the aspects of the disclosed embodiments as defined by the appended claims.

It should be understood that for purposes of the disclosed embodiments, the terms above and below are to be interpreted with respect to a vertical axis of gravity.

### BRIEF DESCRIPTION OF THE DRAWINGS

In the following detailed portion of the present disclosure, the invention will be explained in more detail with reference to the example embodiments shown in the drawings. These embodiments are non-limiting exemplary embodiments, in which like reference numerals represent similar structures throughout the several views of the drawings, wherein:

FIG. 1A illustrates a perspective view of an exemplary gravity fed spray head according to the disclosed embodiments;

FIG. 1B illustrates a cross sectional view of an exemplary gravity fed spray head according to the disclosed embodiments;

FIG. 2 illustrates a coupling according to the disclosed embodiments;

FIG. 3 depicts a sprayer according to the disclosed embodiments;

FIG. 4 shows a schematic diagram of a pump according to the disclosed embodiments;

FIG. 5 shows an embodiment using an electrical pump; and

FIG. 6 depicts a side view of the gravity fed spray head with a container mounted on top.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. The present disclosure is not limited to the embodiments shown, but to be accorded the widest scope consistent with the claims.

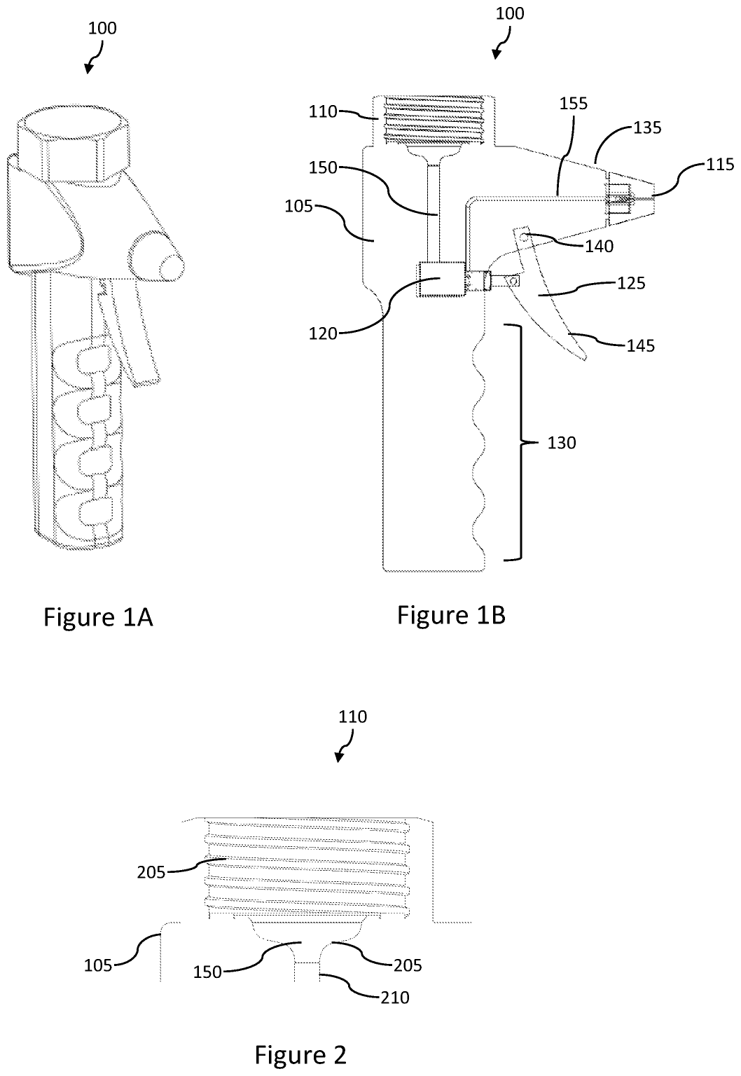

FIG. 1 illustrates an exemplary gravity fed spray head 100 according to the disclosed embodiments. The exemplary gravity spray head includes a housing 105, a coupling 110, a sprayer 115, a pump, 120, and a trigger 125.

The housing 105 may be constructed of plastic, metal, or any material suitable for supporting the components and functions described herein, and may be molded, machined, or otherwise manufactured. The housing 105 may have a number of finger grips 130, for example, at least three, and may enclose the pump 120 and serve as a mount for the coupling 110, sprayer 115, and trigger 125. A container (605, FIG. 6) may be mounted above the housing 105 by the coupling 110.

FIG. 2 illustrates an embodiment of the coupling 110. The coupling 110 may be constructed of plastic, metal, or any suitable material, and may include internal 205 or external threads in order to couple to the container 605 mounted above the coupling 110. In some embodiments, the coupling 110 may be rigidly fixed to a top of the housing 105, providing a connection to the container 605 by rotating the container 110, the housing 105, or both, with respect to each other to engage their respective threads. In other embodiments, the coupling 110 may be rotatably fixed to the housing 105, allowing the coupling 110 to rotate with respect to the housing 105 and the container 605 while engaging threads of the container 605. A feed tube 150 is connected to a bottom of the coupling 110. The feed tube 150 may include a wide upper portion 205 corresponding to an inner diameter of the coupling and a narrower lower portion 210 extending below the upper portion 205.

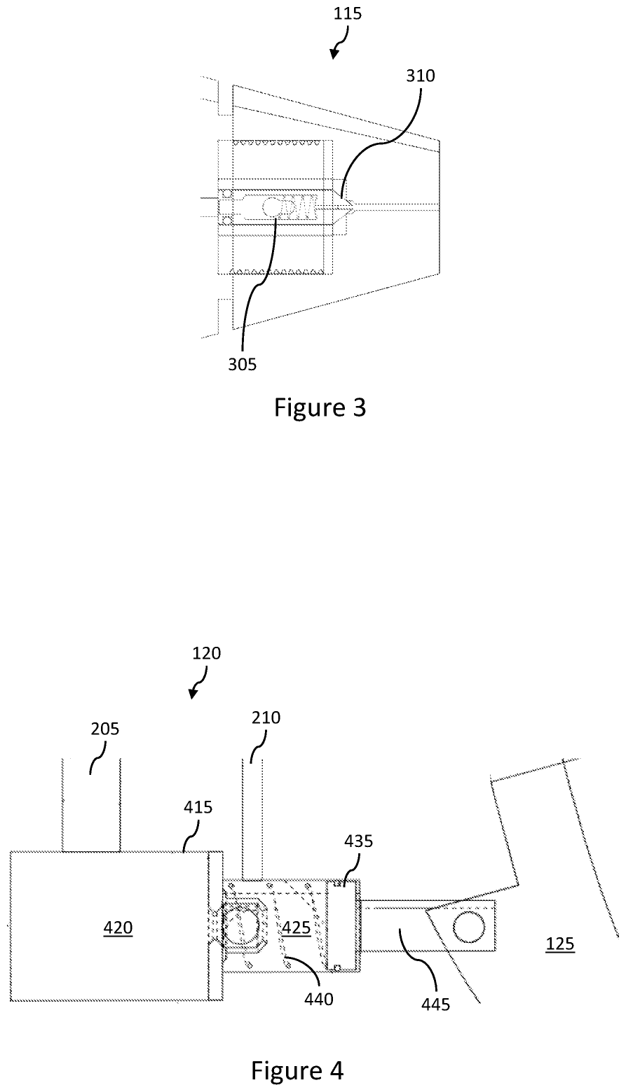

FIG. 3 depicts an embodiment of the sprayer 115. The sprayer 115 may be mounted to a horizontal extension 135 of the housing 105 and may operate to spray liquid from the pump 120. The sprayer 115 may include a check valve 305 and a nozzle 310 that may spray liquid in an adjustable or fixed pattern.

Returning to FIG. 1, the trigger 125 may have a first end 140 attached to the housing 105 below the coupling 110 and the horizontal extension 135, and may have a second end 145 that extends below the pump 120. The first end 140 may be attached to the housing 105 or within the housing 105 using a pin or other fastening mechanism that allows the trigger 125 to rotate with respect to the housing 105. Fastening the first end of the trigger 140 to the housing 105 below the coupling 110, and extending the second end of the trigger below the pump 120, allows for using a fore finger and thumb of a hand to stabilize the container 605 while using the other fingers to operate the trigger 124, and contributes to a providing a wider range of motion for spraying liquid below the container.

The pump 120 may be mounted in the housing 105 and may have an inlet (205, FIG. 4) and an outlet (210, FIG. 4), with a feed tube 150 connected between the coupling 110 and the inlet 205 and an outlet tube 155 connected between the outlet 210 and the sprayer 115. The feed tube 150 may provide a path for liquid between the coupling 110 and the inlet 205, and the outlet tube 155 may provide a path for liquid between the outlet 210 and the sprayer 115.

FIG. 4 shows a schematic diagram of the pump 120. The pump 120 may include the inlet 205 and the outlet 210 located on a side 415 of the pump facing the coupling 110 in order to minimize a length of the liquid paths between the coupling 110 and the inlet 205, and the liquid path between the outlet 210 and the sprayer 115.

In this embodiment, the pump 120 is a mechanical pump with an input reservoir 420, an output reservoir 425, a check valve 240, a piston 435, and a spring 440, biasing the piston 435 away from the check valve 430 and the input reservoir 420. A trigger lever 445 couples the piston 435 to the trigger 125.

During operation of this embodiment, the second end 145 of the trigger 125 may be depressed, that is, rotated toward the housing 105. The second end 145 of the trigger 125 may then be released, this is, rotated away from the housing 105, and the spring 440 forces the piston 435, coupled to the trigger 125 by the trigger lever 445, away from the check valve 430 and the input reservoir 420, causing fluid to be drawn downward from a bottom of the container 605, through the feed tube 150, into the inlet 205 facing the coupling 110, and into the input reservoir 420. The second end 145 of the trigger 125 may then be depressed and released, allowing the spring 440 to push the piston 435 away from the check valve 430 and the input reservoir 420, causing fluid to flow from the input reservoir 425 and through the check valve 430 to fill the output reservoir 425, while fluid is drawn downward from a bottom of the container 605, through the feed tube 150, into the inlet 205 facing the coupling 110, and into the input reservoir 420. The second end 145 of the trigger 125 may then be depressed, forcing fluid in the output reservoir 425 upward through the outlet 210, through the outlet tube 155, and through the sprayer 115.

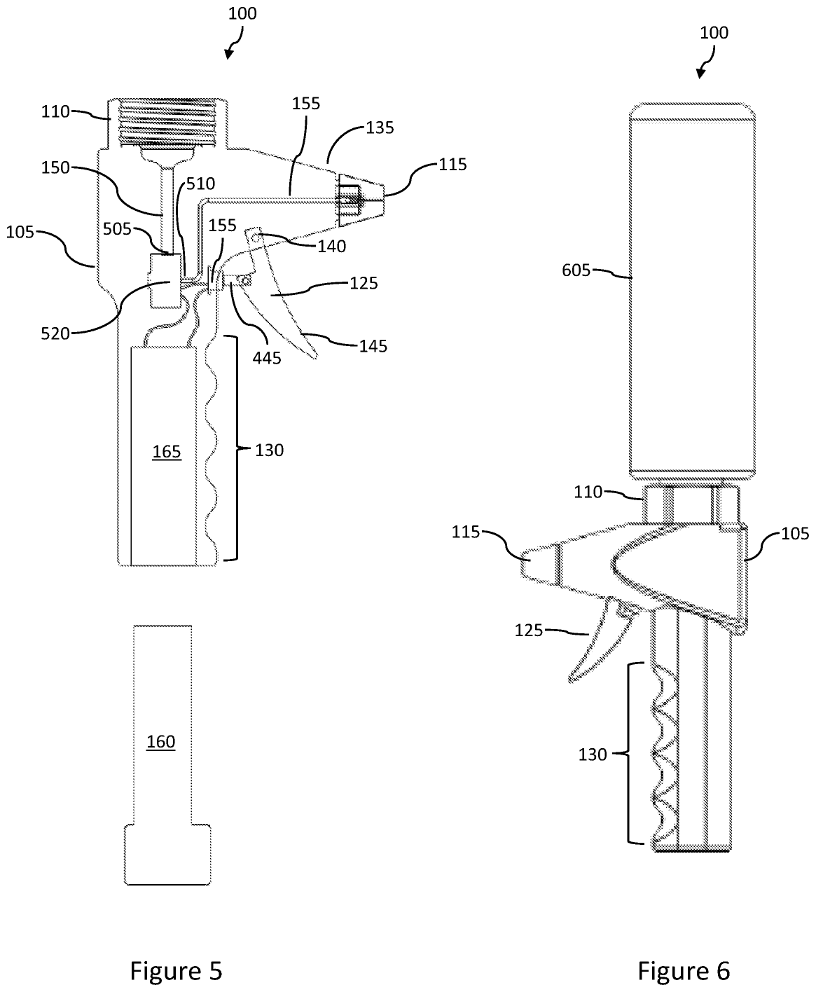

FIG. 5 shows an embodiment where the pump 520 is an electrical pump. This embodiment includes a power source 160, for example, a battery, and a switch 155 for connecting the power source 160 to the pump 520. In this embodiment, the housing 105 may include a cavity 165 into which the power source 160 may be inserted for operation. The trigger lever 445 may couple the trigger 125 to the switch 155. In this embodiment, the inlet 505 faces the coupling 110, while the outlet faces the trigger 125. During operation of this embodiment, the trigger 125 is depressed causing the trigger lever 445 to activate the switch 155 which, when activated, connects the power source 160 to the pump 520. When the pump is powered, the pump 520 draws fluid downward from a bottom of the container 605, through the feed tube 150, into the inlet 205 facing the coupling 110, through the outlet 210, through the outlet tube 155, and through the sprayer 115.

FIG. 6 depicts a side view of the gravity fed spray head 100 with a container 605 mounted on top. By at least mounting the container 605 over the gravity fed spray head 100 and extending the trigger and

The aspects of the disclosed embodiments seek to provide a solution to the existing problems of excessive tilting to utilize portions of the fluid, the amount of wasted fluid, and the limited range of motion that are associated with existing spray bottle assemblies caused by the container being mounted below the spray mechanism.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the presently disclosed invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A gravity fed spray head comprising:
a housing;
a coupling mounted atop the housing for fastening a container above the housing;
a sprayer mounted to a horizontal extension of the housing;
a pump mounted inside the housing below the coupling, the pump having an inlet and an outlet facing the coupling; and
a trigger having a first end rotatably mounted to the housing below the coupling, and a second end extending below the pump, the trigger coupled to a trigger lever for actuating the pump.

2. The gravity spray head of claim 1, wherein the housing comprises at least three finger grips.

3. The gravity spray head of claim 1, wherein the housing encloses the pump and the sprayer and trigger are attached to the housing.

4. The gravity spray head of claim 1, wherein the coupling is rigidly fixed atop the housing.

5. The gravity spray head of claim 1, wherein the coupling comprises internal threads for engaging threads of the container.

6. The gravity spray head of claim 1, wherein the sprayer comprises a nozzle configured to spray liquid in an adjustable or fixed pattern.

7. The gravity spray head of claim 1, further comprising a feed tube connecting the coupling and the inlet.

8. The gravity spray head of claim 7, wherein the feed tube comprises an upper portion with a width corresponding to an inner diameter of the coupling and a lower portion extending from the upper portion to the inlet.

9. The gravity spray head of claim 1, further comprising an outlet tube connecting the outlet and the sprayer.

10. The gravity spray head of claim 1, wherein the pump comprises a piston biased by a spring and coupled to the trigger by the trigger lever.

11. The gravity spray head of claim 1, wherein the pump is an electrical pump, the gravity spray head further comprising:
a power source; and
a switch coupled to the trigger lever for actuating the pump, wherein when the trigger lever is actuated, the trigger activates the switch to connect the power source to the pump.
